(19) United States
(12) Patent Application Publication
(10) Pub. No.: US 2010/0213266 A1
(43) Pub. Date: Aug. 26, 2010

(54) MECHANICAL CALCULATOR

(76) Inventor: Luis Valencia, Rockville, MD (US)

Correspondence Address: Luis Valencia, 13127 Cleveland Dr., Rockville, MD, 20850, US

(21) Appl. No.: 12/390,476

(22) Filed: Feb. 22, 2009

(51) Int. Cl. G06G 1/00

(52) U.S. Cl. 235/70 A; 235/70 R

(57) ABSTRACT

A mechanical calculating apparatus for calculating an output based on a plurality of variables is provided. The apparatus includes a base member having a first plurality of indicia relating to potential values of the output and/or the variables, and a plurality of tabs independently movable with respect to the base member. The tabs have a second plurality of indicia relating to the potential values of the output and/or the variables, and the second indicia are alignable with the first indicia to indicate a value of the output based on the selected values of the variables.

### FIELD OF THE INVENTION

The present invention relates to a mechanical calculating apparatus for calculating an output based on a plurality of variables and a method of using the same.

### BACKGROUND OF THE INVENTION

Cardboard mechanical calculators made for calculating specific quantities are generally known. These calculators typically have values printed thereon and a moving part for aligning with the values. Existing mechanical calculators, however, have numerous drawbacks and limitations. For example, existing mechanical calculators are unable to calculate output values based on more than three variables.

### SUMMARY OF THE INVENTION

A mechanical calculating apparatus for calculating an output based on a plurality of variables is provided. The apparatus includes a base member having a first plurality of indicia relating to potential values of the output and/or the variables, and a plurality of tabs independently movable with respect to the base member. The tabs have a second plurality of indicia relating to the potential values of the output and/or the variables, and the second indicia are alignable with the first indicia to indicate a value of the output based on the selected values of the variables.

The number of tabs may be three and the number of variables may be four. The base member may include a plurality of windows corresponding to the tabs, and the first window may have the first indicia arranged therearound. The tabs are independently movable within the respective windows of the base member.

The output may relate to savings on the purchase of gas. For example, the variables may include: number of gallons of gas to purchase, price of gas, price differential between sources of gas, and miles per gallon of gas. The output may be a maximum number of miles to travel to a cheaper source of gas to save on gas.

More generally, the output may relate to savings on the purchase of a commodity, including the cost of driving an additional distance to take advantage of a lower price for the commodity. For example, the variables may include: number of units of the commodity to purchase, price of gas, price differential between sources of the commodity, and miles per gallon of gas consumed by the vehicle. The output may be a maximum amount of usage of the commodity with a savings.

The base member and tabs may each be substantially rectangular. The base member may include an envelope having two opposing parts providing at least one opening therebetween to allow movement of tabs in and out of the at least one opening.

The tabs may include a first tab disposed within the base member adjacent to a first edge thereof a second tab disposed within the base member adjacent to a second edge thereof, and a third tab disposed within the base member located between said first and second tabs and spaced apart therefrom. The base member may include a first variable indicator with a plurality of first variable values located along the first edge thereof and an output indicator with a plurality of output values located along the second edge thereof. The first tab may include a second variable indicator with a plurality of second variable values located adjacent to the first variable indicator for alignment therewith, and a first alignment: mark spaced apart from the second variable indicator. The second tab includes a third variable indicator with a plurality of third variable values located adjacent to the first alignment mark for alignment therewith, and a second alignment mark spaced apart from the third variable indicator. The third tab may include a fourth variable indicator with a plurality of fourth variable values adjacent to the second alignment mark for alignment therewith, and a third alignment mark spaced apart from the fourth variable values and adjacent to the output values on the base member for alignment therewith. The first tab is moved to align a selected value of the first variable indicator with a selected value of the second variable indicator. The second tab is moved to align a selected value of the third variable indicator with said first alignment mark on the first tab. The third tab is moved to align a selected value of the fourth variable indicator with the second alignment mark on the second tab such that a selected value of the output indicator is aligned with the third alignment mark,

A method of calculating an output based on a plurality of variables using a mechanical calculating apparatus is also provided. The apparatus includes a base member having a first plurality of indicia relating to potential output values of the output and/or the variables, and a plurality of tabs independently movable with respect to the base member. The tabs have a second plurality of indicia relating to the potential values of the output and/or the variables, and the second indicia are alignable with the first indicia to indicate a value of the output based on selected values of the variables. The method includes sequentially arranging each of the tabs with respect to one another to align the second indicia on each of the tabs with the first indicia of the base member and with the second indicia on neighboring tabs, and indicating the output based on the arrangement of the tabs.

### BRIEF DESCRIPTION OF THE DRAWINGS

FIGS. 1A is a top plan view of a mechanical calculator according to an embodiment of the present invention, and FIG. 1B is an exploded view of the mechanical calculator of FIG. 1A;

FIG. 2 shows a mechanical calculator according to another embodiment of the present invention;

FIG. 3 is a cross-sectional view of the calculators shown in FIGS. 1A taken along line A-A′: and

FIG. 4 shows the mechanical calculator of FIG. 1A during a calculation.

### DESCRIPTION OF THE PREFERRED EMBODIMENTS

Embodiments of the present invention will be described below with reference to the drawings.

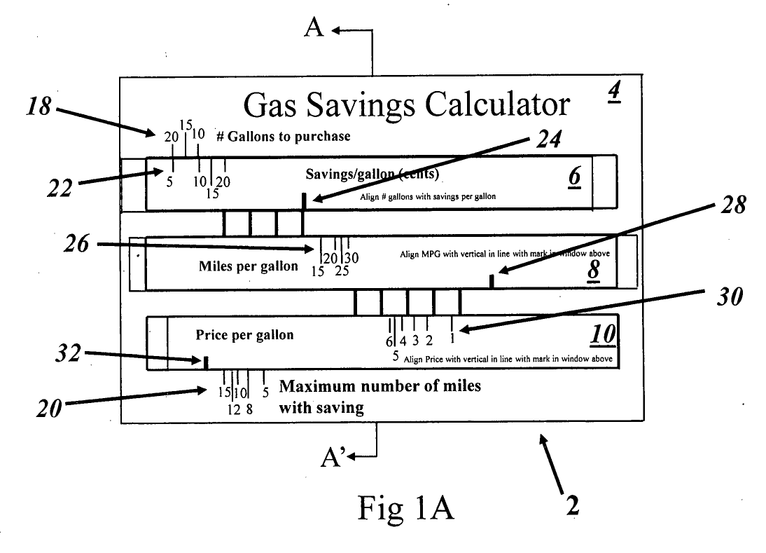

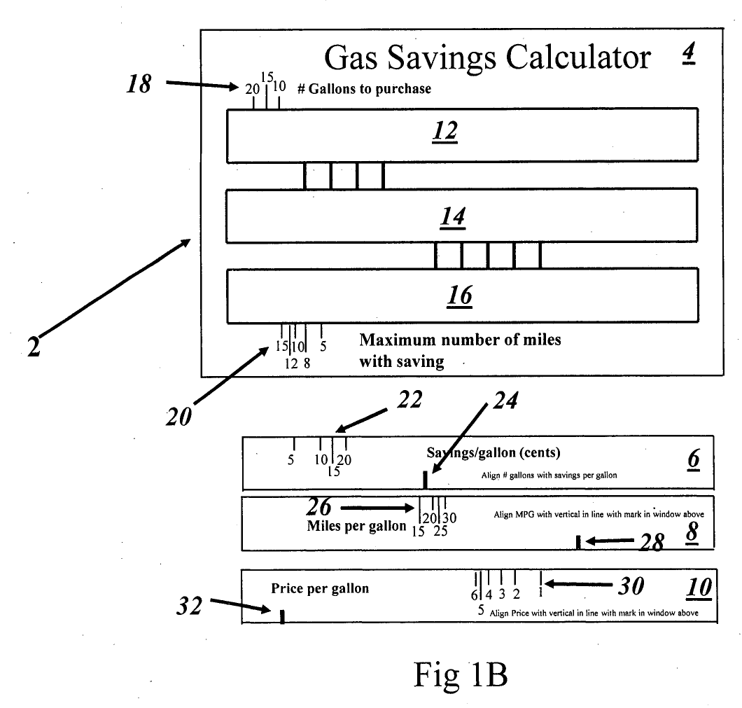

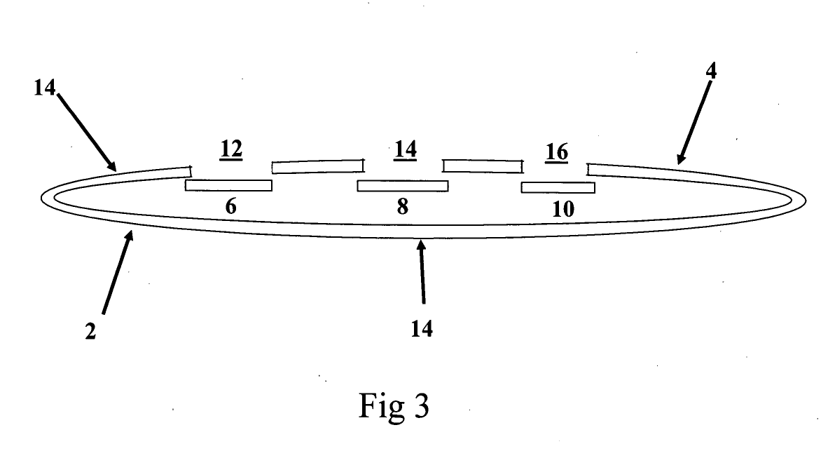

As best shown in FIGS. 1A, 1B and 3, a mechanical calculator 2 includes a base member 4 with three tabs 6, 8, and 10, which are independently movable with respect to the base member. The base member 4 and tabs 6, 8, 10 may be substantially rectangular. As shown in FIG. 3, the base member 4 includes an envelope 12 formed of two opposing parts 14. The top opposing part 14 includes three windows 15, 16, and 17 in which the tabs 6, 8, and 10 are respectively moved. It should be understood that the shapes and dimensions of the base member 4 shown in FIG. 3 have been exaggerated for clarity.

The base member 4 and the tabs 6, 8, and 10 have a plurality of indicia relating to four different variables and an output that is calculated based on the variables. A plurality of first variable values 18 are arranged at one side of the base member 4 adjacent to the first tab 6. A plurality of output values 20 is arranged at another side of the base member 4, opposite to where the first variable values 18 are located adjacent to the third tab 10. The first tab 6 includes a plurality of second variable values 22 and a first alignment mark 24. The second tab 8 includes a plurality of third variable values 26 and a second alignment mark 28. The third tab 10 includes a plurality of fourth variable values 30 and a third alignment mark 32. The locations of the variable values 18, 22, 26, and 30, alignment marks 24, 28, 32, and output values 20 can be determined based on the type of calculation and the equation(s) relating the output value to the variables.

The four variables are used to calculate the distance a person can drive their vehicle to buy cheaper gas, yet still save on their gas purchase. For example, if someone has the choice of driving to gas station A, which is 3 miles away, to buy gas at $3.00 per gallon, or gas station B, which is 10 miles away, to buy gas at $2.90 per gallon, can they save on gas by driving to gas station B?

First, the user determines what the gas price differential between gas station A and B and the number of gallons of gas to be purchased. The user can determine this variable in any number of known ways. Accordingly, the user selects one of the second variable values 22 and one of the first variable values 18 and aligns the selected values by sliding the first tab 6 with respect to the base member 4. Next, the user selects one of the third variable values 26 based on the gas mileage of their vehicle. The selected value of the third variable 26 is then aligned with the first alignment mark 24 on the first tab 6 by moving the second tab 8 with respect to the base member 4 and the first tab 6. Next, the user selects one of the fourth variable values 30 based on the price of gas and aligns the selected value with the second alignment mark 28 on the second tab 8 by sliding the third tab 10 with respect to the base member 4, the first tab 6, and the second tab 8. Finally, the user selects one of the output values 20 that closely aligns with the third alignment mark 32. The selected output value represents the number of miles the user can drive to save on gas, in terms of the difference in distance between the user's location and gas stations A and B. That is, in the example above, if the output value is greater than 7 miles (gas station B (10 miles) minus gas station A (3 miles)), it is cheaper to drive the greater distance to gas station B to buy gas.

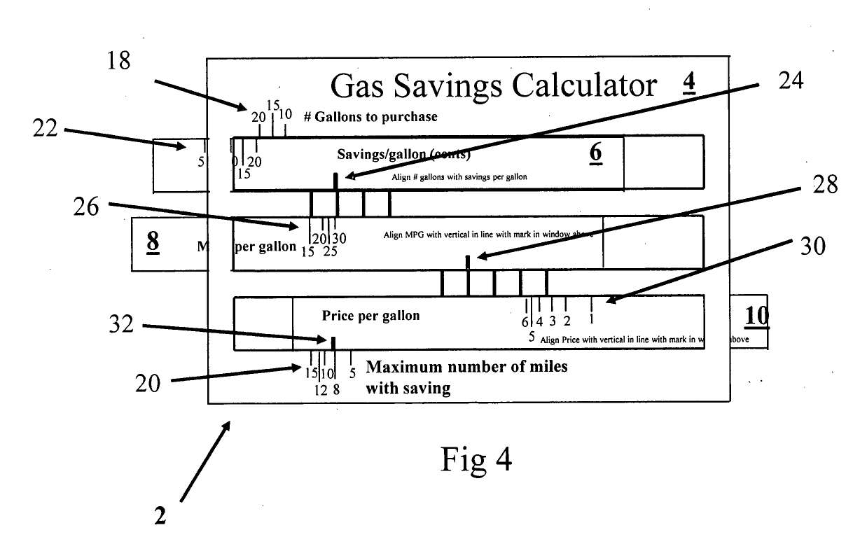

Although the embodiment of the invention shown in FIGS. 1A, 1B, and 3 relates to gas savings, it will be understood that this embodiment is intended to be exemplary and the invention can be embodied in other calculations. FIG. 4 shows an example calculation for a vehicle with a 20 gallon tank that gets 20 miles per gallon, for a difference in price of 10 cents per gallon, and a gas price of $4 per gallon. As shown, the user can drive 10 miles extra to the cheaper gas station and still save on gas.

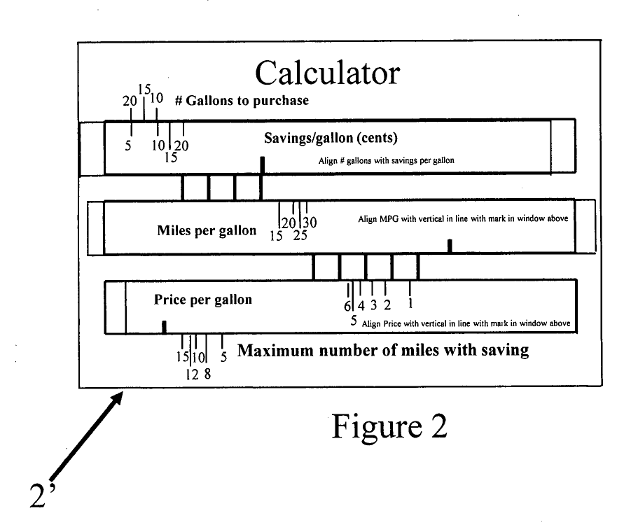

As best shown in FIG. 2, a mechanical calculator 2′ can be used to calculate savings related to a commodity, more generally. In this case, the input variables may be number of units of the commodity to purchase, price differential between sources of the commodity, price per unit of the commodity, and amount of usage per unit of the commodity. The arrangement of variables and the calculation may be performed in a similar manner as the calculator 2 shown in FIGS. 1A, 1B, 3, and 4.

It should be understood by those skilled in the art that various modifications, combinations, sub-combinations and alterations may occur depending on design requirements and other factors insofar as they are within the scope of the appended claims or the equivalents thereof.

I claim:

1. A mechanical calculating apparatus for calculating an output based on a plurality of variables, the apparatus comprising:
a base member having a first plurality of indicia relating to potential values of the output and/or the variables; and
a plurality of tabs independently movable with respect to the base member, said tabs having a second plurality of indicia relating to the potential values of the output and/or the variables, said second indicia alignable with the first indicia to indicate a value of the output based on selected values of the variables.

2. The apparatus according to claim 1, wherein the number of said tabs is three.

3. The apparatus according to claim 1, wherein the number of variables is four.

4. The apparatus according to claim 1, wherein said base member comprises a plurality of windows corresponding to said tabs and having the first indicia arranged therearound, and said tabs are independently movable within respective windows.

5. The apparatus according to claim 1, wherein the output relates to savings on gas.

6. The apparatus according to claim 5, wherein said variables include: number of gallons of gas to purchase, price of gas, price differential between sources of gas, and miles per gallon of gas.

7. The apparatus according to claim 6, wherein said output is a maximum number of miles to travel to a cheaper source of gas to save on gas.

8. The apparatus according to claim 1, wherein the output relates to savings on a purchase of a commodity.

9. The apparatus according to claim 8, wherein said variables include: number of units of the commodity to purchase, price differential between sources of the commodity, price of gas, and gas mileage of the vehicle to be used.

10. The apparatus according to claim 9, wherein said output is maximum number of miles can be driven while still achieving savings.

11. The apparatus according to claim 1, wherein said base member and said tabs are each substantially rectangular.

12. The apparatus according to claim 1, wherein said base member comprises an envelope having two opposing parts providing at least one opening therebetween to allow movement of said tabs in and out of said at least one opening.

13. The apparatus according to claim, wherein:
said tabs include a first tab disposed within said base member adjacent to a first edge thereof a second tab disposed within said base member adjacent to a second edge thereof, and a third tab disposed within said base member between said first and second tabs and spaced apart therefrom;
said base member comprises a first variable indicator with a plurality of first variable values located along said first edge thereof and an output indicator with a plurality of output values locate along said second edge;
said first tab includes a second variable indicator with a plurality of second variable values located adjacent to said first variable indicator for alignment therewith and a first alignment mark;
said second tab includes a third variable indicator with a plurality of third variable values located adjacent to said first alignment mark for alignment therewith and a second alignment mark;
said third tab includes a fourth variable indicator with a plurality of fourth variable values adjacent to said second alignment mark for alignment therewith, and a third alignment mark spaced apart from the fourth variable indicator and adjacent to said output values on said base member for alignment therewith.

14. The apparatus according to claim 13, wherein the first tab is moved to align a selected value of the first variable indicator with a selected value of the second variable indicator, the second tab is moved to align a selected value of the third variable indicator with said first alignment mark on said first tab, the third tab is move to align a selected value of the fourth variable indicator with said second alignment mark on said second tab such that a selected value of the output indicator is aligned with said third alignment mark.

15. A method of calculating an output based on a plurality of variables using a mechanical calculating apparatus including a base member having a first plurality of indicia relating to the potential values of output and/or the variables, and a plurality of tabs independently movable with respect the base member, the tabs having a second plurality of indicia relating to the potential values of the output and/or the variables, the second indicia alignable with the first indicia to indicate a value of the output based on selected values of the variables, the method comprising:
sequentially arranging each of the tabs with respect to one another to align the second indicia on each of the tabs with the first indicia of the base member and with the second indicia on neighboring tabs; and
indicating the output based on the arrangement of the tabs.
